(19) United States
(12) Patent Application Publication
(10) Pub. No.: US 2026/0141872 A1
(43) Pub. Date: May 21, 2026

(54) METHOD AND SYSTEM FOR OBTAINING LINE OVERDRIVE LOOKUP TABLE, CALIBRATION METHOD, DEVICE AND MEDIUM

(71) Applicant: AMLOGIC (SHENZHEN) CO., LTD, Shenzhen, (CN)

(72) Inventors: Yuning Chen, Shenzhen, Guangdong (CN); Qi Feng, Shenzhen, Guangdong (CN)

(21) Appl. No.: 19/337,798

(22) Filed: Sep. 23, 2025

(30) Foreign Application Priority Data
Nov. 19, 2024 (CN) 202411662696.4

(51) Int. Cl. G09G 3/36

(52) U.S. Cl. CPC G09G 3/3607; G09G 2320/0233; G09G 2360/145

(57) ABSTRACT

The present disclosure discloses a system and a method for obtaining a line overdrive lookup table, a calibration method, a device, and a medium. The method for obtaining a line overdrive lookup table includes: driving an LCD to output images with different color channel combinations under a grayscale level n; obtaining a mixed brightness value of the LCD that is corresponding to each color channel combination and a plurality of brightness component values corresponding to the color channel combination; obtaining a brightness deviation between a sum of the plurality of brightness component values and the corresponding mixed brightness value; obtaining a target grayscale level compensation value corresponding to the current grayscale level n based on a deviation direction of the brightness deviation; and obtaining target grayscale level compensation values corresponding to all grayscale levels to form the line overdrive lookup table.

### CROSS-REFERENCE TO RELATED APPLICATION

The present application claims priority to Chinese Patent Application No. 202411662696.4 filed with China National Intellectual Property Administration on Nov. 19, 2024 and entitled “METHOD AND SYSTEM FOR OBTAINING LINE OVERDRIVE LOOKUP TABLE, CALIBRATION METHOD, DEVICE AND MEDIUM”, which is incorporated herein by reference in its entirety.

### TECHNICAL FIELD

The present disclosure relates to the technical field of optoelectronic display, and more particularly, to a method for obtaining a line overdrive lookup table of a liquid crystal display and a system for obtaining a line overdrive lookup table of a liquid crystal display, an automatic brightness calibration method for a liquid crystal display, an electronic device and a computer readable storage medium.

### BACKGROUND

In a driving process of liquid crystal display (LCD) display panels, Line overdrive (LOD) is an effective technology for improving a display quality of LCD panels. The basic principle of LOD technology is to perform lookup table compensation output for a charging voltage of a row of pixel liquid crystal cells to a charging voltage of a next row of pixel liquid crystal cells on the same source line (Source Line) in each frame of image in the panel, and utilize variations in the charging voltages to compensate for abnormal display brightness of pixel liquid crystal units caused by excessively slow discharge or insufficient charging due to excessively short row scanning time at different grayscale levels. LOD technology is widely applied in display liquid crystal panels with Dual-gate or Tri-gate architectures.

At present, in order to achieve the best LOD effect in the actual hardware environment, it is necessary to adjust the relationship between the driving voltage and the grayscale level to ensure the uniformity and accuracy of the brightness of the LCD under different grayscale levels and color channel combinations. The existing generation method of the LOD lookup table requires step-by-step testing and calculation of different luminance performances under 0 to n grayscale level combinations, to confirm the brightness deviation caused by the charging and discharging of the pixel liquid crystal unit. In the process, the operator needs to manually compare the brightness deviations of respective grayscale levels and constantly adjust the compensation value to optimize the difference between the output grayscale level and the actual brightness. The entire debugging process is not only cumbersome and time-consuming, but also prone to human errors, resulting in the LOD lookup table not being precise enough. Furthermore, due to the different characteristics and driving conditions of liquid crystal panels from various manufacturers, the table lookup data provided by panel manufacturers may not achieve the best effect under specific hardware environment. Therefore, the existence of these issues diminishes the actual performance effectiveness of LOD technology.

### SUMMARY

The present disclosure aims to resolve at least one of the technical problems existing in the related art. Therefore, one aim of the present disclosure is to provide a method for obtaining a line overdrive lookup table of a liquid crystal display (LCD). The method realizes the automatic generation of the line overdrive lookup table, and does not need to rely on human power for testing and comparison, simplifying the operation process, reducing human errors, and improving the accuracy of the line overdrive lookup table, thereby providing precise data support for the subsequent automatic brightness calibration of the LCD.

A second aim of the present disclosure is to provide an automatic brightness calibration method for an LCD.

A third aim of the present disclosure is to provide a system for obtaining a line overdrive lookup table of an LCD.

A fourth aim of the present disclosure is to provide an electronic device.

A fifth aim of the present disclosure is to provide a non-transitory computer readable storage medium.

To achieve the above aims, an embodiment of a first aspect of the present disclosure provides the method for obtaining a line overdrive lookup table of a liquid crystal display (LCD). The method includes: driving the LCD to output images with different color channel combinations under a grayscale level n; obtaining a mixed brightness value of the LCD that is corresponding to each color channel combination and a plurality of brightness component values corresponding to the color channel combination; obtaining a brightness deviation between a sum of the plurality of brightness component values and the corresponding mixed brightness value; obtaining a target grayscale level compensation value corresponding to the current grayscale level n based on a deviation direction of the brightness deviation; and obtaining target grayscale level compensation values corresponding to all grayscale levels to form the line overdrive lookup table.

In the method for obtaining a line overdrive lookup table of an LCD according to the embodiment of the present disclosure, the LCD is driven to output images with different color channel combinations under a grayscale level n, a mixed brightness value that is corresponding to each color channel combination and a plurality of brightness component values corresponding to the color channel combination are obtained. Therefore, the brightness performance of each color channel combination and the plurality of corresponding single color channels under different grayscale levels on the LCD can be accurately reflected. A brightness deviation between a sum of the plurality of brightness component values and the corresponding mixed brightness value is calculated, and therefore the difference between the actual brightness performance and the expected brightness performance of the LCD under the current driving condition can evaluated. Based on a deviation direction of the brightness deviation, the adjustment or compensation value required for each input grayscale level signal, that is a target grayscale level compensation value corresponding to the current grayscale level n, can be automatically calculated by using preset calibration algorithms and can be recorded, to facilitate subsequent corrections to the brightness output of the LCD. The aforementioned process will be repeated, until the target grayscale level compensation values corresponding to all grayscale levels are obtained, thereby automatically generating a calibrated line overdrive lookup table. Through the method of the present disclosure, there is no need to rely on human power for test and comparison, simplifying the operation process, reducing human errors, and improving the accuracy of the line overdrive lookup table, thereby providing precise data support for the subsequent automatic calibration of the LCD brightness.

In some embodiments, the driving the LCD to output the images with the different color channel combinations under the grayscale level n includes: successively outputting images with different color channel combinations under different grayscale levels in an ascending or descending order; or driving, according to a preset way, the LCD to output to poll grayscale levels segmented by all grayscale level compensation values.

In some embodiments, the method further includes: selecting the color channel combination based on a color channel arrangement structure or a driving mode of the LCD.

In some embodiments, the obtaining the mixed brightness value of the LCD that is corresponding to each color channel combination and the plurality of brightness component values corresponding to the color channel combination includes at least one of: obtaining a mixed brightness value of the LCD that is corresponding to a simultaneous driving of an R channel, a B channel and a G channel, a brightness component value of the R channel, a brightness component value of the B channel and a brightness component value of the G channel that are corresponding to the color channel combination; obtaining the mixed brightness value of the LCD that is corresponding to a simultaneous driving of the R channel, the B channel and the G channel, the brightness component value of the R channel and a brightness component value of a combination of the B channel and the G channel that are corresponding to the color channel combination; obtaining the mixed brightness value of the LCD that is corresponding to a simultaneous driving of the R channel, the B channel and the G channel, the brightness component value of the G channel and a brightness component value of a combination of the R channel and the B channel that are corresponding to the color channel combination; or obtaining the mixed brightness value of the LCD that is corresponding to a simultaneous driving of the R channel, the B channel and the G channel, the brightness component value of the B channel, and a brightness component value of a combination of the R channel and the G channel that are corresponding to the color channel combination.

In some embodiments, the obtaining the mixed brightness value of the LCD that is corresponding to each color channel combination and the plurality of brightness component values corresponding to the color channel combination includes at least one of: obtaining a mixed brightness value of the LCD that is corresponding to a simultaneous driving of an R channel and a B channel, a brightness component value of the R channel and a brightness component value of the B channel that are corresponding to the color channel combination; obtaining a mixed brightness value of the LCD that is corresponding to a simultaneous driving of the R channel and a G channel, the brightness component value of the R channel and a brightness component value of the G channel that are corresponding to the color channel combination; or obtaining a mixed brightness value of the LCD that is corresponding to a simultaneous driving of the G channel and the B channel, the brightness component value of the G channel and the brightness component value of the B channel that are corresponding to the color channel combination.

In some embodiments, the obtaining the target grayscale level compensation value corresponding to the current grayscale level n based on the deviation direction of the brightness deviation includes: determining, when a value of the brightness deviation is less than a brightness deviation threshold, a current grayscale level compensation value of the LCD as the target grayscale level compensation value corresponding to the current grayscale level n.

In some embodiments, the obtaining the target grayscale level compensation value corresponding to the current grayscale level n based on the deviation direction of the brightness deviation further includes: adjusting, when the brightness deviation value is greater than or equal to the brightness deviation threshold, the current grayscale level compensation value of the LCD according to the deviation direction; and obtaining a new brightness deviation value, and adjusting the grayscale level compensation value of the LCD based on a deviation direction of the new brightness deviation value until the brightness deviation value is less than the brightness deviation threshold.

In some embodiments, the obtaining the target grayscale level compensation value corresponding to the current grayscale level n based on the deviation direction of the brightness deviation includes: adjusting, via dichotomy, the grayscale level compensation value based on a value between a maximum allowable grayscale level compensation value and a minimum allowable grayscale level compensation value of the current grayscale level n until the brightness deviation value is less than or equal to the brightness deviation threshold; or repeatedly increase or decrease the gray scale compensation value by one according to the deviation direction of the brightness deviation until the brightness deviation value is less than or equal to the brightness

In some embodiments, the brightness deviation threshold is set according to a color channel arrangement structure of the LCD or is a customized value.

In some embodiments, the method further includes: exporting the line overdrive lookup table and saving it in a preset file format.

To achieve the above aims, an automatic brightness calibration method for an LCD according to an embodiment in a second aspect of the present disclosure includes: invoking, in response to an automatic brightness calibration initiation command for the LCD, a line overdrive lookup table obtained by the method for obtaining a line overdrive lookup table of an LCD according to any one of the above embodiments; and performing grayscale level compensation calibration on the LCD according to the line overdrive lookup table.

In the automatic brightness calibration method for an LCD according to the embodiment of the present disclosure, in response to an automatic brightness calibration initiation command for the LCD, the system can automatically invoke the line overdrive lookup table obtained by the method for obtaining a line overdrive lookup table of an LCD according to the embodiment above. The lookup table records the target grayscale level compensation values for the LCD at different grayscale levels. Based on these compensation values, the system can adjust the input grayscale signal. These signals are converted into actual driving voltage values through the digital-to-analog converter (DAC) inside the LCD panel. Therefore, through adjusting the grayscale level signal using the target grayscale level compensation value, the system can indirectly achieve adjustment of the driving voltage. By accelerating or decelerating the charging and discharging process of the LCD, deviations in the output brightness of the LCD screen can be compensated for, to ensure that the brightness performance of different grayscale levels and different color channel combinations meets expectations. This method can complete brightness calibration without manual operation, making the operation process more simplified, reducing human errors, and ensuring that the brightness performance of the LCD screen become more uniform and precise. This enhances the consistency and accuracy of the LCD screen's brightness performance across various grayscale levels and color combinations, further optimizing the display quality of the LCD panel.

To achieve the above aims, a system for obtaining a line overdrive lookup table of an LCD according to an embodiment in a third aspect of the present disclosure includes: a detecting device configured to detect a brightness value of a target LCD; and a controlling device connected to the detecting device and configured to perform the method for obtaining a line overdrive lookup table of an LCD according to any of the above embodiments.

In the system for obtaining a line overdrive lookup table of an LCD according to the embodiment of the present disclosure, the controlling device is connected to the detecting device and implements the method for obtaining a line overdrive lookup table of an LCD as described in any of the above embodiments to drive the LCD to output images with different color channel combinations under a grayscale level n and obtain a mixed brightness value that is corresponding to each color channel combination and a plurality of brightness component values corresponding to each color channel combination, which can accurately reflect the brightness performance of each color channel combination and a plurality of corresponding single color channels on the LCD under different grayscale levels. By calculating a brightness deviation between a sum of the plurality of brightness component values and the corresponding mixed brightness value, the difference between the actual brightness performance and the expected brightness performance of the LCD under the current driving condition can be evaluated. Based on the deviation direction of the brightness deviation and by using a preset calibration algorithm, a required adjustment or compensation value for each input grayscale level signal, that is the target grayscale level compensation value corresponding to the current grayscale level n, can be automatically calculated and is recorded, to facilitate subsequent correction of the brightness output by the LCD. The aforementioned process will be repeated, until the target grayscale level compensation values corresponding to all grayscale levels are obtained, thereby automatically generating a calibrated line overdrive lookup table. Through the method of the present disclosure, there is no need to rely on human power for testing and comparison, thereby simplifying the operation process, reducing human errors, and improving the accuracy of the line overdrive lookup table, thereby providing precise data support for the subsequent automatic calibration of the LCD brightness.

In some embodiments, the controlling device includes: a driving module provided with the line overdrive lookup table and configured to drive the target LCD based on the line overdrive lookup table; and a working platform connected with the detecting device and the driving module and configured to obtain the brightness value and control the driving module.

To achieve the above aims, an electronic device according to an embodiment of the fourth aspect of the present disclosure includes: at least one processor; and a memory communicatively connected to the at least one processor. The memory stores a computer program executable by the at least one processor, the computer program when executed by the at least one processor, implements the method for obtaining a line overdrive lookup table of an LCD according to any of the above embodiments or implements the automatic brightness calibration method for an LCD according to any of the above embodiments.

The electronic device according to the embodiment of the present disclosure, through executing the method for obtaining a line overdrive lookup table of an LCD in any of the above embodiments or implementing the computer program for an automatic brightness calibration method for an LCD in any of the above embodiments, achieves automated operations of line overdrive lookup table generation and brightness calibration. The entire process does not need to be relied on manual testing and comparison, simplifying the operational process, reducing human errors, and improving the accuracy of the line overdrive lookup table, thereby ensuring the consistency and accuracy of brightness performance across various grayscale levels and color combinations of the LCD, ultimately enhancing the display quality of LCD panels.

To achieve the above aims, a non-transitory computer readable storage medium according to an embodiment of the fifth aspect of the present disclosure is provided. A computer program is stored on the computer readable storage medium. The computer program when executed, implements the method for obtaining a line overdrive lookup table of an LCD according to any of the above embodiments or implements the automatic brightness calibration method for an LCD according to any of the above embodiments.

The computer readable storage medium according to the embodiment of the present disclosure, by using the method for obtaining a line overdrive lookup table of an LCD in any of the above embodiments or the automatic brightness calibration method for an LCD in any of the above embodiments, achieves automated operations of line overdrive lookup table generation and brightness calibration. The entire process does not need to be relied on manual testing and comparison, simplifying the operational process, reducing human errors, and improving the accuracy of the line overdrive lookup table, thereby ensuring the consistency and accuracy of brightness performance across various grayscale levels and color combinations of the LCD, ultimately enhancing the display quality of LCD panels.

The additional aspects and advantages of the present disclosure will be partially presented in the following description, partially become apparent from the description below, or be understood through the practice of the present disclosure.

### BRIEF DESCRIPTION OF THE DRAWINGS

The above and/or other additional aspects and advantages of the present disclosure become apparent and comprehensible from the description of embodiments in connection with accompanying drawings, in which:

FIG. 1 is a flow chart of a method for obtaining a line overdrive lookup table of a liquid crystal display according to an embodiment of the present disclosure;

FIG. 2 is a schematic diagram of a RGB channel combination under grayscale level n according to an embodiment of the present disclosure;

FIG. 3 is an overall flow chart of a method for obtaining a line overdrive lookup table of an LCD according to still an embodiment of the present disclosure;

FIG. 4 is a flow chart for an automatic brightness calibration method for an LCD according to an embodiment of the present disclosure;

FIG. 5 is a block diagram of a system for obtaining a line overdrive lookup table of an LCD according to another embodiment of the present disclosure; and

FIG. 6 is a block diagram of an electronic device according to an embodiment of the present disclosure.

### REFERENCE NUMERALS

system for obtaining a line overdrive lookup table of an LCD 100;
detecting device 1; controlling device 2;
driving module 21; working platform 22;
electronic device 200;
processor 201; memory 202.

### DETAILED DESCRIPTION

The following describes the embodiments of the present disclosure in detail. The embodiments described with reference to the accompanying drawings are exemplary.

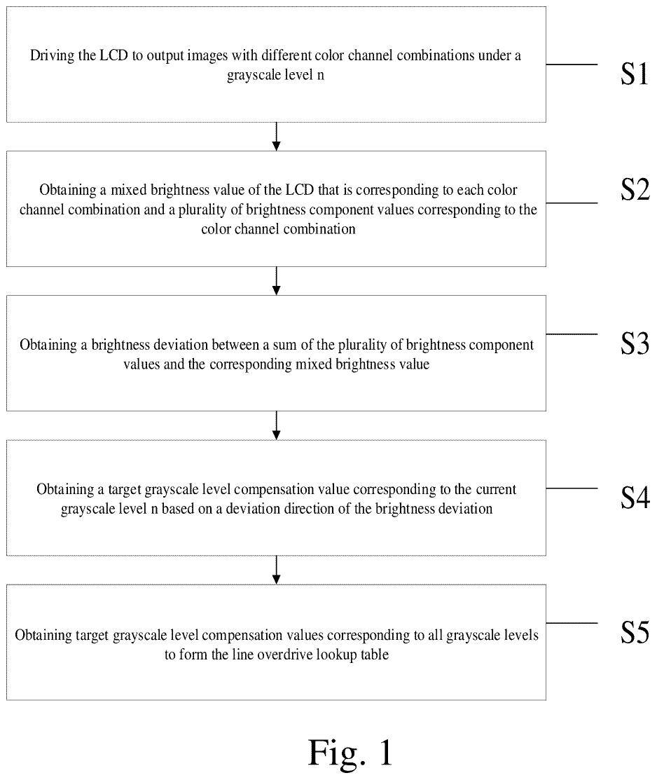

The following describes a method for obtaining a line overdrive lookup table of a liquid crystal display (LCD) according to an embodiment of the present disclosure with reference to FIG. 1 to FIG. 3.

FIG. 1 is a flow chart of a method for obtaining a line overdrive lookup table of an LCD according to an embodiment of the present disclosure. As shown in FIG. 1, the method for obtaining a line overdrive lookup table of an LCD according to the embodiment of the present disclosure at least includes steps S1-S5.

At step S1, the LCD is driven to output images with different color channel combinations under a grayscale level n.

In some embodiments, an LCD is a display device that controls light transmission through backlight and liquid crystal materials and can have different resolutions, for example: standard definition (HD) resolution 1366*768, full high definition (FHD) resolution 1920*1080, ultra high definition (UHD) resolution 3840*2160 or other resolutions. The LCD adopts a color architecture of three distinct color filters of R (Red), G (Green), and B (Blue). Complete image display can be achieved by relying on the grayscale combination of R, G, and B three colors.

In some embodiments, a grayscale level can be used to represent a brightness level of a pixel. Each grayscale level represents a different brightness value, that is different brightness levels from black to white in an image can be achieved by different grayscale level values. More grayscale levels cause richer brightness gradations displayed on the LCD, resulting in more refined image detail representation.

In some embodiments, the value range of n in grayscale level n can be determined by the bit depth of a display system. A higher bit depth causes more grayscale levels. For example, for a 8-bit system (8 bit depth), a grayscale level range is 0 to 255 corresponding to 256 brightness levels; for a 10-bit system (10 bit depth), a grayscale level range is 0 to 1023 corresponding to 1024 brightness levels; for a 12-bit system (12 bit depth), a grayscale level range is 0 to 4095 corresponding to 4096 brightness levels.

In some embodiments, the system controls display of the LCD through a driving circuit, and outputs images of predefined color channel combinations at different grayscale levels (e.g., 0 to 255 levels). For example, based on three primary colors of RGB, an image with a single color of R (red), G (green), B (blue), or various combinations thereof (such as R (red)+G (green), R (red)+B (blue), G (green)+B (blue), and R (red)+G (green)+B (blue)) can be generated.

At step S2, a mixed brightness value of the LCD that is corresponding to each color channel combination and a plurality of brightness component values corresponding to the color channel combination are obtained.

In some embodiments, the mixed brightness value may refer to an overall brightness produced by the combination of RGB color channels on the liquid crystal screen at a specific grayscale level. The brightness component value may refer to a brightness output of each individual color channel in a specific color channel combination when displaying the specific color channel combination. For example, if the specific color channel combination is “R (Red)+G (Green)”, the brightness component values include a brightness component value of the red channel and a brightness component value of the green channel.

In some embodiments, the mixed brightness value and the plurality of brightness component values of each color channel combination of the LCD can be obtained via a color analyzer, a photoelectric sensor and other detection devices. During testing, each color channel (R, G, B) is individually enabled and a brightness component value thereof is measured, and then brightness measurements for various combinations are performed sequentially, such as a combination of R+G and a combination of R+B etc., so as to obtain the mixed brightness value thereof.

At step S3, a brightness deviation between a sum of the plurality of brightness component values and the corresponding mixed brightness value is obtained.

Specifically, the system sums the brightness component values under the same color channel combination and compares the resulting sum with the measured mixed brightness value to obtain a brightness deviation value. The brightness deviation value represents the difference between an actual brightness and a theoretical brightness of a multi-channel combination, primarily reflecting the brightness difference caused by characteristics of the LCD or insufficient driving voltage. Thus, the calculation of brightness deviation is to evaluate the performance of LCD under a current driving condition, provides directional data for subsequent calibration and enables the final generated lookup table to effectively reflect the actual brightness.

At step S4, a target grayscale level compensation value corresponding to the current grayscale level n is obtained based on a deviation direction of the brightness deviation.

In some embodiments, the target grayscale level compensation value may refer to the value used to adjust or compensate for each input grayscale level signal so as to correct a brightness of the LCD output, thereby achieving the desired brightness output under different grayscale level inputs.

At step S5, target grayscale level compensation values corresponding to all grayscale levels are obtained to form the line overdrive lookup table.

Specifically, the target grayscale level compensation value corresponding to each grayscale level is recorded as an adjustment or calibration value for the grayscale level. The process covers all the grayscale levels, from the darkest grayscale level (for example grayscale level 0) to the brightest grayscale level (for example grayscale level 255 or higher). Target grayscale level compensation values for all grayscale levels are sequentially arranged to form a complete line overdrive lookup table. For LCD with different resolutions and different color combinations, the lookup table can have different formats and different refinement levels. For example, if the LCD is a 8-bit grayscale level display, the lookup table will contain 256 grayscale level compensation values (from grayscale level 0 to grayscale level 255); if the LCD is a 10-bit grayscale level display, the lookup table will contain 1024 grayscale level compensation values.

Furthermore, the generated line overdrive lookup table will serve as a reference database for automatic brightness calibration, provides precise data support to ensure that the brightness performance of the LCD screen meets expectations, thereby enhancing the uniformity, consistency and accuracy of the display effect.

In the method for obtaining a line overdrive lookup table of an LCD according to the embodiment of the present disclosure, the LCD is driven to output images with different color channel combinations under a grayscale level n, a mixed brightness value that is corresponding to each color channel combination and a plurality of brightness component values corresponding to the color channel combination are obtained. Therefore, the brightness performance of each color channel combination and the plurality of corresponding single color channels under different grayscale levels on the LCD can be accurately reflected. A brightness deviation between a sum of the plurality of brightness component values and the corresponding mixed brightness value is calculated, and therefore the difference between the actual brightness performance and the expected brightness performance of the LCD under the current driving condition can evaluated. Based on a deviation direction of the brightness deviation, the adjustment or compensation value required for each input grayscale level signal, that is a target grayscale level compensation value corresponding to the current grayscale level n, can be automatically calculated by using preset calibration algorithms and can be recorded, to facilitate subsequent corrections to the brightness output of the LCD. The aforementioned process will be repeated, until the target grayscale level compensation values corresponding to all grayscale levels are obtained, thereby automatically generating a calibrated line overdrive lookup table. Through the method of the present disclosure, there is no need to rely on human power for test and comparison, simplifying the operation process, reducing human errors, and improving the accuracy of the line overdrive lookup table, thereby providing precise data support for the subsequent automatic calibration of the LCD brightness.

In some embodiments, the driving the LCD to output the images with the different color channel combinations under the grayscale level n includes: successively outputting images with different color channel combinations under different grayscale levels in an ascending or descending order; or driving, according to a preset way, the LCD to output to poll grayscale levels segmented by all grayscale level compensation values.

The ascending or descending order can be an order from a low grayscale level to a high grayscale level (ascending) or from a high grayscale level to a low grayscale level (descending). The images with different color channel combinations under different grayscale levels are successively outputted on the LCD, for example, images of a single color of R (Red), G (Green), B (Blue) or various mixed colors thereof (such as RG (Red+Green), RB (Red+Blue), GB (Green+Blue), RGB (Red+Green+Blue) etc.). The method can ensure that the display effect under each grayscale level combination can be presented continuously, facilitating gradual adjustment and calibration of each grayscale level.

In some embodiments, the polling in the preset way may refer to dividing the grayscale levels into a plurality of small grayscale level intervals based on calibration requirements of grayscale levels, and sequentially driving the LCD to output corresponding images according to these segmented intervals. Through this way, the system can more meticulously traverse various calibration values and ensure display consistency across the entire grayscale range. The polling way offers a high flexibility and is capable of rapidly testing specific grayscale or color combinations according to testing requirements, without conforming to a fixed ascending or descending order, and enables faster testing of the LCD screen's brightness performance to save calibration time.

In some embodiments, the system can drive the LCD to output RGB channel combination patterns under grayscale levels from 0 to n. The grayscale level n refers to the grayscale level of three color channels of R G, and B. There may be different combination ways. For example, all color channels are simultaneously at the same grayscale level (e.g., the grayscale level n); or two color channels remain at a fixed grayscale level while the other color channel varies (its output changes from the grayscale level 0 to n).

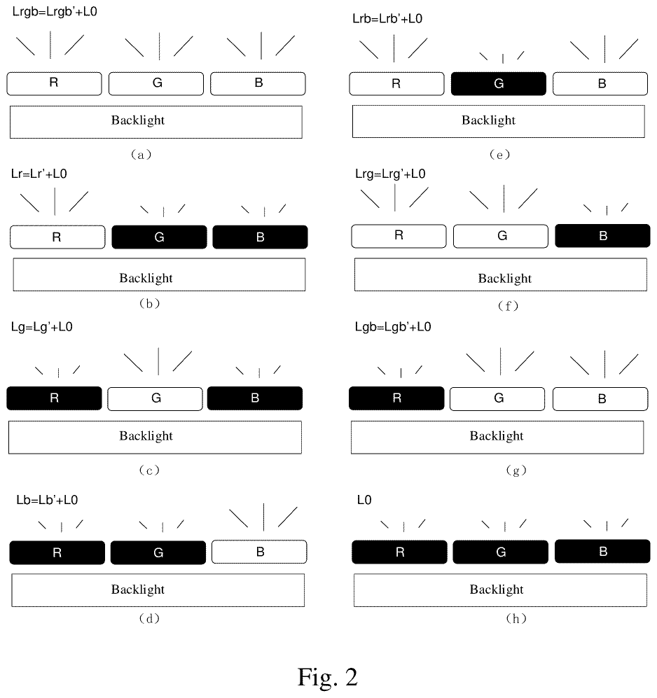

FIG. 2 is a schematic diagram of a RGB channel combination under a grayscale level n according to an embodiment of the present disclosure. As shown in FIG. 2, (a) in FIG. 2 shows the simultaneous driving of three color channels of R (red), G (green), and B (blue). The R, G, and B color channels can sample the same grayscale level value n, meaning all three color channels of R, G, and B are at the same grayscale level. Alternatively, the grayscale level values of two color channels can be fixed, the output of a third color channel changes from the grayscale level 0 to the grayscale level n, and thus this combination is used to detect display effects under different grayscale levels. Here, Lrgb represents brightness data obtained after simultaneously driving the three color channels of R, G, and B, and represents the brightness of an overall RGB combination. Lrgb′ represents a weighted component of the driving brightness of the R, G, B color channels. L0 represents a light transmittance brightness of the LCD panel itself in a black screen state (also referred to as backlight brightness), and this brightness value is used to calibrate the actual brightness of the LCD, eliminating the influence of backlight.

FIG. 2 shows in (b) that only the R (red) color channel is driven. The output of the R (red) color channel varies within the range of grayscale levels 0 to n. The testing method is used to measure the brightness output of the R (Red) color channel under different grayscale levels. Here, Lr represents the brightness data obtained after driving the R (red) color channel. Lr′ represents the brightness component obtained after driving the R (red) color channel. L0 represents the transmittance brightness of the LCD panel itself in a black screen state.

FIG. 2 shows in (c) that only the G (green) color channel is driven. The output of the G (green) color channel varies within the range of grayscale levels 0 to n. The testing method is used to measure the brightness output of the G (green) color channel under different grayscale levels. Here, Lg represents the brightness data obtained after driving the G (green) color channel. Lg′ represents the brightness component obtained after driving the G (green) color channel. L0 represents the transmittance brightness of the LCD panel itself in a black screen state.

FIG. 2 shows in (d) that only the B (blue) color channel is driven. The output of the B (blue) color channel varies within the range of grayscale levels 0 to n. The testing method is used to measure the brightness output of the B (blue) color channel under different grayscale levels, meaning that the B (blue) color channel can display the grayscale level range from darkest to brightest. Lb represents the brightness data obtained after driving the B (blue) color channel. Lb′ represents the brightness component obtained after driving the B (blue) color channel. L0 represents the transmittance brightness of the LCD panel itself in a black screen state.

FIG. 2 shows in (e) that the R (red) and B (blue) color channels are simultaneously driven. Outputs of the two color channels vary within the range of grayscale levels 0 to n, while the G (green) color channel is not driven. The combination is used to measure the brightness performance of the R (Red) and B (Blue) color channels under a mixed driving condition. Lrb represents the brightness data obtained after simultaneously driving the R (red) and B (blue) color channels. Lrb′ represents a weighted brightness component obtained after simultaneously driving of the R (Red) and B (Blue) color channels. L0 represents the transmittance brightness of the LCD panel itself in a black screen state.

FIG. 2 shows in (f) that the R (red) and G (green) color channels are simultaneously driven. Outputs of the two color channels vary within the range of grayscale levels 0 to n and therefore the two color channels output different grayscale level combinations respectively, while the B (blue) color channel is not driven. The combination is used to measure the brightness performance of the R (Red) and G (green) color channels under a mixed driving condition. Lrg represents the brightness data obtained after simultaneously driving the R (red) and G (green) color channels. Lrg′ represents a weighted brightness component obtained after simultaneously driving of the R (Red) and G (green) color channels. L0 represents the transmittance brightness of the LCD panel itself in a black screen state.

FIG. 2 shows in (g) that the G (green) and B (blue) color channels are simultaneously driven. Outputs of the two color channels vary within the range of grayscale levels 0 to n and therefore the two color channels output different grayscale level combinations respectively, while the R (red) color channel is not driven. The combination is used to measure the brightness performance of the G (green) and B (blue) color channels under a mixed driving condition. Lgb represents the brightness data obtained after simultaneously driving the G (green) and B (blue) color channels. Lgb′ represents a weighted brightness component obtained after simultaneously driving of the G (green) and B (blue) color channels. L0 represents the transmittance brightness of the LCD panel itself in a black screen state.

FIG. 2 shows a grayscale level 0 driving pixel in (h), that is a state in which the color channel does not display an image, and shows a backlight transmission brightness in a black screen state. The brightness in the grayscale level 0 represents the light transmittance brightness of the screen when the color channels are completely undriven. This is a reference value used for correcting other grayscale level brightness data, and is used to deduct the influence of backlight to more accurately measure the brightness at various grayscale levels.

In summary, through the brightness testing of monochromatic color channels (such as R, G, B) and mixed driving (such as RB, RG, GB), a more comprehensive analysis of the performance of the LCD panel under different grayscale level combinations can be achieved. These brightness data (such as Lb, Lrb, Lrg, etc.) not only reflect the brightness conditions at various grayscale levels, but also can be used to further analyze the contribution of each color channel to the overall brightness through the weighted components (such as Lb′, Lrb′, Lrg′, etc.). At the same time, by measuring the brightness (L0) of the grayscale level 0, an impact of backlight on total brightness can be better corrected, ensuring more accurate brightness data for each grayscale level.

In some embodiments, the color channel combination is selected based on a color channel arrangement structure or a driving mode of the LCD. Specifically, the color channel combination is selected according to the gate driving mode (such as single gate, dual gate, tri gate, etc.) of the LCD panel, the source driving mode of the panel (such as flip mode (a flip source driving mode), stripe mode (a stripe source driving mode), etc.), and the liquid crystal structure mode of the panel (such as IPS mode (in-plane switching mode), VA mode (vertical alignment mode), etc.), and panel's performance in displaying RGB pure colors and mixed colors (such as color saturation and color coordinates) when the LOD function of the panel is not enabled.

Gate drive modes (such as single gate, dual gate, and tri gate modes) affect the data refresh rate and charging time. For example, in the tri gate mode, a front-end system needs to simultaneously process three rows of data (i.e., one row of R, one row of G, one row of B) within a scanning time of one row. This may result in insufficient charging, and thus result in insufficient monochromatic brightness performance. In this case, it is necessary to conduct independent tests for each channel (R, G, B), and detects a relationship between the individually output brightness component values and the composite brightness values of the combined output.

In some embodiments, the source driving mode (such as flip, stripe, and other modes) determines how the source signal drives the color channels. Selecting an appropriate driving mode can affect the charging efficiency and response speed of the RGB channels.

In some embodiments, different liquid crystal structures (such as IPS, VA, etc.) have different viewing angles and different response characteristics. Based on the specific structure of the LCD, the color channel combination can be better selected, so as to ensure the color performance under various viewing angles.

In some embodiments, before the LOD function is enabled, the color saturation and chromaticity coordinates of the LCD when displaying RGB primary colors can be tested, and thus its performance is evaluated to select the most suitable color channel combination.

In some embodiments, when selecting the output RGB grayscale level combination, the output RGB grayscale level combination can be selected based on the color channel arrangement structure of the LCD. That is, an appropriate RGB grayscale level combination is selected based on the arrangement sequence of an immediately previous row of color channels and a current row of color channels in the same vertical data drive line of the LCD panel. The grayscale combinations of (a), (b), (c), and (d) in FIG. 2 involve respectively the brightness combinations of the R, G, and B color channels and the calculation of their component brightness differences. The grayscale combinations of (e), (f), (g), and (h) in FIG. 2 involve calculating the brightness differences regarding a combination of two of the R, G, and B color channels.

In some embodiments, the obtaining the mixed brightness value of the LCD that is corresponding to each color channel combination and the plurality of brightness component values corresponding to the color channel combination includes at least one of the followings.

Firstly, a mixed brightness value of the LCD that is corresponding to a simultaneous driving of an R channel, a B channel and a G channel, a brightness component value of the R channel, a brightness component value of the B channel and a brightness component value of the G channel that are corresponding to the color channel combination are obtained. Theoretically, the mixed brightness value of the R channel, the B channel, and the G channel is equal to a sum of weighted components of driving brightness values of the R, G, and B color channels and a transmittance brightness value of the LCD panel itself in the black screen state. The weighted components of the driving brightness for the R, G, and B color channels are equal to a sum of a brightness component value corresponding to the R channel, a brightness component value corresponding to the B channel, and a brightness component value corresponding to the G channel in the color channel combination. The specific formulas are as follows:

$${Lrgb}^{′} = {Lr}^{′} + {Lg}^{′} + {Lb}^{′} ;$$

$$Lrgb = {Lrgb}^{′} + L 0.$$

Lrgb represents a mixed brightness value of the LCD that is corresponding to a simultaneous driving of an R channel, a B channel and a G channel. Lrgb′ represents a weighted component of the driving brightness for R, G, B color channels. L0 represents a transmittance brightness value of the LCD panel itself in a black screen state. Lr′ represents a luminance component value corresponding to the R channel in the color channel combination. Lg′ represents a luminance component value corresponding to the G channel in the color channel combination. Lb′ represents a luminance component value corresponding to the B channel in the color channel combination.

Secondly, the mixed brightness value of the LCD that is corresponding to a simultaneous driving of the R channel, the B channel and the G channel, the brightness component value of the R channel and a brightness component value of a combination of the B channel and the G channel that are corresponding to the color channel combination are obtained. Theoretically, the mixed brightness value of the R channel, the B channel, and the G channel is equal to a sum of weighted components of the driving brightness of the R, G, B color channels and the transmittance brightness value of the LCD panel itself in the black screen state. The weighted component of the driving brightness for the R, G, and B color channels is equal to a sum of the brightness component value of the R channel and the brightness component value of the combination of the B and G channels. The brightness data obtained through driving the R channel is equal to a sum of the brightness component value of the R channel and the transmittance brightness value of the LCD panel itself in the black screen state. The specific formulas are as follows:

$$Lrgb = {Lrgb}^{′} + L 0 ;$$

$${Lrgb}^{′} = {Lr}^{′} + {Lgb}^{′} ;$$

$$Lr = {Lr}^{′} + L 0.$$

Lrgb represents a mixed brightness value that is corresponding to a simultaneous driving of an R channel, a B channel and a G channel. Lrgb′ represents a weighted component of the driving brightness for the R, G and B color channels. L0 represents a transmittance brightness of the LCD panel itself in a black screen state. Lrgb′ represents the weighted component of the driving brightness of the R, G and B color channels. Lr represents the brightness value obtained for driving the R channel. Lr′ represents the brightness component value of the R channel corresponding to the color channel combination. Lgb′ represents the brightness component value for the combination of the B channel and the G channel.

Thirdly, the mixed brightness value of the LCD that is corresponding to a simultaneous driving of the R channel, the B channel and the G channel, the brightness component value of the G channel and a brightness component value of a combination of the R channel and the B channel that are corresponding to the color channel combination are obtained. Theoretically, the mixed brightness value of the R channel, the B channel, and the G channel is equal to a sum of a weighted component of the driving brightness of the R, G, B color channels and the transmittance brightness value of the LCD panel itself in the black screen state. The weighted component of the driving brightness for the R, G, and B color channels is equal to a sum of a brightness component value of the G channel and a brightness component value of a combination of the R and B channels, and the brightness data obtained through driving the G channel is equal to a sum of the brightness component value of the G channel and the transmittance brightness value of the LCD panel itself in the black screen state. The specific formulas are as follows:

$$Lrgb = {Lrgb}^{′} + L 0 ;$$

$${Lrgb}^{′} = {Lg}^{′} + {Lrb}^{′} ;$$

$$Lg = {Lg}^{′} + L 0.$$

Lrgb represents a mixed brightness value that is corresponding to a simultaneous driving of an R channel, a B channel and a G channel. Lrgb′ represents a weighted component of the driving brightness of the R, G and B color channels. L0 represents the transmittance brightness of the LCD panel itself in a black screen state. Lrgb′ represents a weighted component of the driving brightness of the R, G and B color channels. Lg represents a brightness value obtained for driving the G channel. Lg′ represents a brightness component value of the G channel corresponding to the color channel combination. Lrb′ represents a brightness component value of the combination of the R channel and the B channel.

Fourthly, the mixed brightness value of the LCD that is corresponding to a simultaneous driving of the R channel, the B channel and the G channel, the brightness component value of the B channel, and a brightness component value of a combination of the R channel and the G channel that are corresponding to the color channel combination are obtained. Theoretically, the mixed brightness value of the R channel, the B channel, and the G channel is equal to a sum of the weighted component of the driving brightness of the R, G, B color channels and the transmittance brightness value of the LCD panel itself in the black screen state. The weighted component of the driving brightness of the R, G, and B color channels is equal to a sum of the brightness component value of the B channel and the brightness component value of a combination of the R and G channels. The brightness data obtained through driving the B channel is equal to a sum of the brightness component value of the B channel and the transmittance brightness value of the LCD panel itself in the black screen state. The specific formulas are as follows:

$$Lrgb = {Lrgb}^{′} + L 0 ;$$

$${Lrgb}^{′} = {Lb}^{′} + {Lrg}^{′} ;$$

$$Lb = {Lb}^{′} + L 0.$$

Lrgb represents the mixed brightness value that is corresponding to a simultaneous driving of the R channel, the B channel and the G channel. Lrgb′ represents a weighted component of driving brightness for the R, G and B color channels. L0 represents the transmittance brightness of the LCD panel itself in a black screen state. Lrgb′ represents the weighted component of the driving brightness of the R, G and B color channels. Lb represents a brightness data value obtained through driving the B channel. Lb′ represents a brightness component value of the B channel corresponding to the color channel combination. Lrg′ represents a brightness component value of the combination of the R channel and the G channel.

In some embodiments, the obtaining the mixed brightness value of the LCD that is corresponding to each color channel combination and the plurality of brightness component values corresponding to the color channel combination includes at least one of the followings.

Firstly, a mixed brightness value of the LCD that is corresponding to a simultaneous driving of an R channel and a B channel, a brightness component value of the R channel and a brightness component value of the B channel that are corresponding to the color channel combination are obtained. Theoretically, the mixed brightness value of the R channel and B channel is equal to a sum of a weighted brightness component obtained by simultaneously driving the R and B color channels and a transmission light brightness value of the LCD panel itself in the black screen state. The weighted brightness component obtained through the simultaneously driving of the R and B color channels is equal to a sum of a brightness component value of the R channel and a brightness component value of the B channel. The specific formulas are as follows:

$$Lrb = {Lrb}^{′} + L 0 ;$$

$${Lrb}^{′} = {Lr}^{′} + {Lb}^{′} .$$

Lrb represents the mixed brightness value that is corresponding to the simultaneous driving of the R channel and the B channel. Lrb′ represents the weighted brightness component obtained by the simultaneous driving of the R and B color channels. L0 represents the transmission light brightness value of the LCD panel itself in a black screen state. Lr′ represents the brightness component value corresponding to the R channel of the color channel combination. Lb′ represents the brightness component value corresponding to the B channel of the color channel combination.

Secondly, a mixed brightness value of the LCD that is corresponding to a simultaneous driving of the R channel and a G channel, the brightness component value of the R channel and a brightness component value of the G channel that are corresponding to the color channel combination are obtained. Theoretically, the mixed brightness value of the R channel and the G channel is equal to a sum of a weighted brightness component obtained by simultaneously driving the R and G color channels and a transmission light brightness value of the LCD panel itself in the black screen state. The weighted brightness component obtained through the simultaneous driving of the R and G color channels is equal to a sum of a brightness component value of the R channel and a brightness component value of the G channel. The specific formulas are as follows:

$$Lrg = {Lrg}^{′} + L 0 ;$$

$${Lrg}^{′} = {Lr}^{′} + {Lg}^{′} .$$

Lrg represents the mixed brightness value that is corresponding to the simultaneous driving of the R channel and the G channel. Lrg′ represents the weighted brightness component obtained by the simultaneous driving of the R and G color channels. L0 represents the transmission light brightness value of the LCD panel itself in a black screen state. Lr′ represents the brightness component value corresponding to the R channel of the color channel combination. Lg′ represents the brightness component value corresponding to the G channel of the color channel combination.

Thirdly, a mixed brightness value of the LCD that is corresponding to a simultaneous driving of the G channel and the B channel, the brightness component value of the G channel and the brightness component value of the B channel that are corresponding to the color channel combination are obtained. Theoretically, the mixed brightness value of the G channel and the B channel is equal to a sum of the weighted brightness component obtained by simultaneously driving the G and B color channels and the transmission light brightness value of the LCD panel itself in the black screen state. The weighted brightness component obtained through the simultaneous driving of the G and B color channels is equal to a sum of a brightness component value of the G channel and a brightness component value of the B channel. The specific formulas are as follows:

$$Lgb = {Lgb}^{′} + L 0 ;$$

$${Lgb}^{′} = {Lg}^{′} + {Lb}^{′} .$$

Lgb represents the mixed brightness value that is corresponding to the simultaneous driving of the G channel and the B channel. Lgb′ represents the weighted brightness component obtained by the simultaneous driving of the G and B color channels. L0 represents the transmission light brightness value of the LCD panel itself in a black screen state. Lg′ represents the brightness component value corresponding to the G channel of the color channel combination. Lb′ represents the brightness component value corresponding to the B channel of the color channel combination.

In some embodiments, due to the driving circuit and charge-discharge characteristics of the LCD, the measured actual brightness may deviate from the theoretically calculated brightness, especially under a grayscale level in the intermediate range. The deviation is mainly due to the fact that in the pixel liquid crystal units on the same data drive line, the charging and discharging speeds of a row of pixel liquid crystal units will be different from the charging and discharging speeds of an adjacent row of pixel liquid crystal units under different driving conditions. This discrepancy can affect the actual brightness output. Thus, the driving voltage of LCD panels varies at different grayscale levels, resulting in different actual charge charging and discharging rates and affecting brightness performance. At an extremely low grayscale level (approaching the grayscale level 0) or extremely high grayscale level (approaching the highest grayscale level), the brightness difference is usually not obvious. However, in the grayscale level in the intermediate range, the brightness difference becomes particularly prominent. The grayscale level in the intermediate range actually has the following situations:

$${Lrgb}^{′} > {Lr}^{′} + {Lg}^{′} + {Lb}^{′} ;$$

$${Lrgb}^{′} > {Lr}^{′} + {Lgb}^{′} ;$$

$${Lrgb}^{′} > {Lg}^{′} + {Lrb}^{′} ;$$

$${Lrgb}^{′} > {Lr}^{′} + {Lb}^{′} ;$$

$${Lrb}^{′} > {Lr}^{′} + {Lb}^{′} ;$$

$${Lrg}^{′} > {Lr}^{′} + {Lg}^{′} ;$$

$${Lgb}^{′} > {Lg}^{′} + {Lb}^{′} .$$

The parameters on the left side of the symbol “=” and the symbol “>” in the formulas are defined as left values; conversely, the parameters on the right side of these symbols are defined as right values. Based on the left and right values of the above formulas, the brightness deviation between a sum of a plurality of brightness component values and the corresponding mixed brightness value can be calculated. The brightness deviation value can be a difference obtained by subtracting the right value from the left value in the above formulas, or can be the percentage value of the difference between the right value and the left value.

In the embodiment of the present disclosure, the brightness deviation value can be obtained by subtracting the right value from the left value, or by subtracting the left value from the right value. It can be a percentage calculated by dividing the difference between the two values by the left value, or a percentage calculated by dividing the difference between the two values by the right value and taking the percentage, or can be obtained any other measurement method that directly or indirectly reflects the brightness deviation value.

In the embodiment, a brightness deviation threshold refers to a brightness deviation value or brightness error range that is allowed by the system. It can be a unidirectional value or an interval value. For example, the brightness deviation threshold as the unidirectional value can be set to <1%. The brightness deviation threshold as the interval value can be set to +1%, or the brightness deviation threshold as the interval value can be set to <1% and greater than-2%.

In the embodiment, a deviation direction of the brightness deviation refers to but not limited to the manifestation described as follows.

When the measured brightness deviation value approaches or deviates from the brightness deviation threshold, the direction of increasing or decreasing the grayscale level compensation value for the current grayscale level n is adjusted, or the direction of selecting the grayscale level compensation value under the current grayscale level n to jump to a smaller or larger value is adjusted.

In some embodiments, the obtaining the target grayscale level compensation value corresponding to the current grayscale level n based on the deviation direction of the brightness deviation includes: determining, when a value of the brightness deviation is less than a brightness deviation threshold, a current grayscale level compensation value of the LCD as the target grayscale level compensation value corresponding to the current grayscale level n.

The brightness deviation threshold may refer to a brightness error range that is permitted by the system, and can be set according to the color channel arrangement structure of the LCD or can be a customized value. For the color channel arrangement structure of the LCD, the color channel arrangement structure of the LCD determines its color display manner. For example, in common RGB arrangement structure, the proportion and arrangement of the red, green, and blue channels can affect the overall brightness distribution of the screen. Therefore, independent brightness deviation thresholds can be set for respective color channels based on the specific channel arrangement structure to address minor output variations across different channels.

For the customized value, users can customize the brightness deviation threshold according to specific application requirements. For example, in scenarios requiring high color consistency, the brightness deviation threshold can be set to +0.5% or lower. However, under normal display requirements, the brightness deviation threshold can be set to +1%. A customized setting allows flexible adjustment of brightness precision based on application requirements, improving display consistency.

Furthermore, in some embodiments, the single-gate LCD exhibits higher brightness stability because of manufacturing and driving manners, therefore the brightness calibration result of the single-gate LCD can be used as a standard to set the brightness deviation threshold for other screens. For example, precise brightness calibration can first be performed on a single-gate LCD. After a deviation threshold setting of the single-gate LCD is obtained, the deviation range is determined as the reference target for other LCD to make all screens approach the brightness level as the benchmark. This can significantly improve brightness consistency among display devices.

In some embodiments, if the system already has certain target LCDs that have undergone rigorous brightness calibration, the brightness performance of these screens can serve as a benchmark for brightness calibration of other displays. For newly assembled LCD equipments or a large batch of LCD equipments, they can be calibrated based on the brightness characteristics of the target LCD screen when leaving factory or during installation, thereby reducing brightness adjustment time and ensuring display effect consistency among devices.

In some embodiments, the brightness deviation threshold can be set based on a limit value of the grayscale level compensation in the line overdrive lookup table. The limit value can be the upper and lower limits of the grayscale level compensation value, corresponding to the maximum and minimum brightness of the RGB color channels respectively. If it is still not possible to make the deviation between the left and right values reach the brightness deviation threshold after a plurality of adjustments, then it is possible that the grayscale level compensation value has already reached its maximum or minimum value, i.e., already reached the adjustment limit.

In some embodiments, when the brightness deviation value is within the preset brightness deviation threshold (such as ±1%), it can represent that a sum of a plurality of brightness component values approximates the corresponding mixed brightness value, that is the current grayscale level brightness output has already approached the target brightness and the grayscale level compensation value at this point can be directly set as the target grayscale level compensation value without further adjustment.

In some embodiments, the obtaining the target grayscale level compensation value corresponding to the current grayscale level n based on the deviation direction of the brightness deviation further includes: adjusting, when the brightness deviation value is greater than or equal to the brightness deviation threshold, the current grayscale level compensation value of the LCD according to the deviation direction. This indicates that the current grayscale level compensation value cannot meet the required brightness accuracy requirements. At this point, it is necessary to adjust the grayscale level compensation value according to the deviation direction to reduce the actual brightness of the LCD screen at the current grayscale level, so as to achieve the target brightness level.

Furthermore, after adjusting the grayscale level compensation value each time, the system can re-obtain a new brightness deviation value, and adjust the grayscale compensation value of the LCD based on the deviation direction of the new brightness deviation value. Through this cyclic adjustment process, the system can continuously adjust the grayscale level compensation value until the brightness deviation value is less than the brightness deviation threshold, that is, the target grayscale level compensation value corresponding to the current grayscale level n is obtained.

Therefore, the method ensures continuous dynamic adjustment of the brightness deviation value, and is applicable for precise brightness control of the LCD at different grayscale levels. At each grayscale level, the system achieves high-precision brightness output by continuously updating the brightness deviation value and adjusting the grayscale level compensation value.

In some embodiments, the obtaining the grayscale level compensation value corresponding to the current grayscale level n based on the deviation direction of the brightness deviation includes: adjusting, via dichotomy, the grayscale level compensation value based on a value between a maximum allowable grayscale level compensation value and a minimum allowable grayscale level compensation value of the current grayscale level n until the brightness deviation value is less than or equal to the brightness deviation threshold.

The dichotomy can be an optimization algorithm based on binary search. This method continuously iterates and adjusts the grayscale level compensation value by using the maximum allowable grayscale level compensation value and the minimum allowable grayscale level compensation value of the current grayscale level n as the initial range for the dichotomy. Specifically, firstly, a midpoint value between the current maximum allowable grayscale level compensation value and the minimum allowable grayscale level compensation value is calculated and the midpoint value is determined as a new grayscale level compensation value. Then, the brightness deviation value under the new grayscale level compensation value is measured, and it is determined whether the brightness deviation value is less than or equal to the brightness deviation threshold. If the brightness deviation value does not meet the threshold requirement, the adjustment range is further narrowed down based on the direction of deviation. If the current brightness deviation value is high, the current grayscale level compensation value of the LCD is reduced. The process will be continuously repeated until a suitable grayscale level compensation value is found, ensuring that the brightness deviation is less than or equal to the brightness deviation threshold.

For example, it is assumed that the current maximum allowable grayscale level compensation value is 128, the minimum allowable grayscale level compensation value is 64, and the brightness deviation threshold is set to 1%. The system first selects the midpoint value of 96 between 128 and 64, as the initial grayscale level compensation value. After detecting brightness deviation, if the deviation direction shows a brightness higher than the target value, the compensated output grayscale level value is reduced to 80. After each adjustment, the brightness deviation value is re-detected until the deviation is below 1%. The method can rapidly narrow down the deviation range until the brightness deviation is less than or equal to the brightness deviation threshold.

In addition to the dichotomy method, other polling methods can also be employed, such as the sequential increment or decrement method. The method achieves gradually approaching the target grayscale compensation value by either incrementing or decrementing repeatedly the grayscale compensation value by one until the brightness deviation reaches the predefined threshold. For example, the method of repeatedly increasing by one can start from the current grayscale level compensation value and gradually increase the grayscale level value. For example, the grayscale level value starts from 80, and is increased to 90, 100, and so on, until the appropriate grayscale level compensation value is found. However, the method of repeatedly decreasing by one involves gradually reducing the grayscale level compensation value starting from a larger value until the brightness deviation requirement is met. Through these methods, the system can flexibly adjust the grayscale level compensation value for each grayscale level, ensuring the accuracy and consistency of the LCD brightness performance.

In some embodiments, the system can export the line overdrive lookup table and save it in a preset file format. Specifically, the target grayscale level compensation value corresponding to the current grayscale level n is obtained based on the deviation direction of the brightness deviation. Target grayscale level compensation values for all grayscale levels can form a complete line overdrive lookup table. The generated line overdrive lookup table data can be saved in binary format or a specific format. To ensure data consistency and compatibility across different platforms, the system can also perform format conversion on the lookup table and select the preset file format for storage. For example, common formats such as CSV format, BIN format, or TXT format can be chosen. Selecting CSV format facilitates data viewing and editing in a table tool. Selecting the BIN format can improve the compactness of data storage. Selecting TXT format enhances the universality of the file. The flexible storage format option not only facilitates the access and retrieval of calibration data, but also adapts to different parsing environments, enhancing the compatibility of the lookup table across a plurality of platforms.

In addition, to further optimize storage space and costs, the system can adopt simplified line overdrive lookup table values. Under the method, the system can select target grayscale level compensation values at specific grayscale levels for storage through either equidistant or non-equidistant sampling methods. An equidistant sampling method selects grayscale level points at fixed intervals for storage. However, a non-uniform interval sampling method preserves more data in areas with significant grayscale variations or requiring fine adjustments, ensuring higher precision in brightness calibration.

To ensure the effective application of compensation values in a simplified lookup table, the system can adopt the bilinear interpolation method to estimate the grayscale level compensation values that are not directly stored. By performing linear interpolation on the compensation values of adjacent grayscale levels in the simplified lookup table, the system can accurately calculate the compensation value for intermediate grayscale level points, thereby ensuring the continuity and precision of brightness calibration. The method can not only save storage space but also reduce storage costs while ensuring calibration accuracy.

In some embodiments, the exported line overdrive lookup table file can also include additional information (such as calibration timestamps, device numbers, calibration operator details, etc.), to ensure data traceability. When the LCD requires re-calibration or adjustment, the line overdrive lookup table can be reimported into the system to update previous calibration data, thereby maintaining consistency in screen display quality.

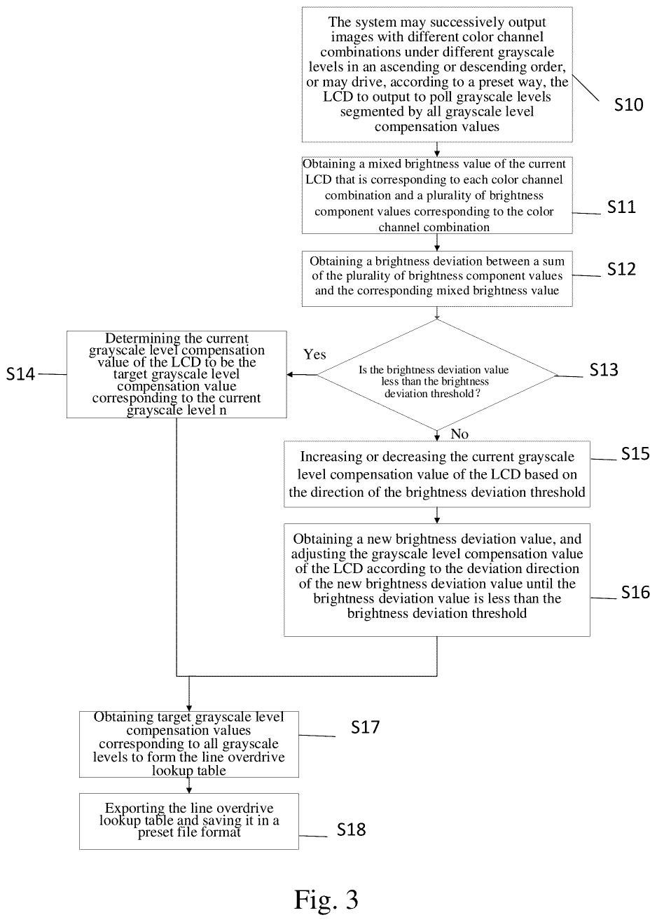

FIG. 3 is an overall flow chart of a method for obtaining a line overdrive lookup table of an LCD according to an embodiment of the present disclosure. As shown in FIG. 3, an overall flow of the method for obtaining a line overdrive lookup table of an LCD at least includes steps S10-S18.

At step S10, the system may successively output images with different color channel combinations under different grayscale levels in an ascending or descending order, or may drive, according to a preset way, the LCD to output to poll grayscale levels segmented by all grayscale level compensation values.

At step S11, a mixed brightness value of the current LCD that is corresponding to each color channel combination and a plurality of brightness component values corresponding to the color channel combination are obtained.

At step S12, a brightness deviation between a sum of the plurality of brightness component values and the corresponding mixed brightness value is obtained.

At step S13, it is determined whether the brightness deviation value is less than the brightness deviation threshold. If yes, the method proceeds to step S14; if not, the method proceeds to step S15.

At step S14, the current grayscale level compensation value of the LCD is determined to be the target grayscale level compensation value corresponding to the current grayscale level n.

At step S15, the current grayscale level compensation value of the LCD is increased or decreased based on the direction of the brightness deviation threshold.

At step S16, a new brightness deviation value is obtained, and the grayscale level compensation value of the LCD is adjusted according to the deviation direction of the new brightness deviation value until the brightness deviation value is less than the brightness deviation threshold.

At step S17, target grayscale level compensation values corresponding to all grayscale levels are obtained to form the line overdrive lookup table.

At step S18, the line overdrive lookup table is exported and is saved in a preset file format.

Above all, through the aforementioned steps for obtaining a line overdrive lookup table of an LCD, the automatic generation of the overdrive lookup table is achieved, eliminating the need for manual testing and comparison, simplifying the operational process, reducing human errors, and improving the accuracy of the line overdrive lookup table, thereby providing precise data support for subsequent automatic brightness calibration of the LCD.

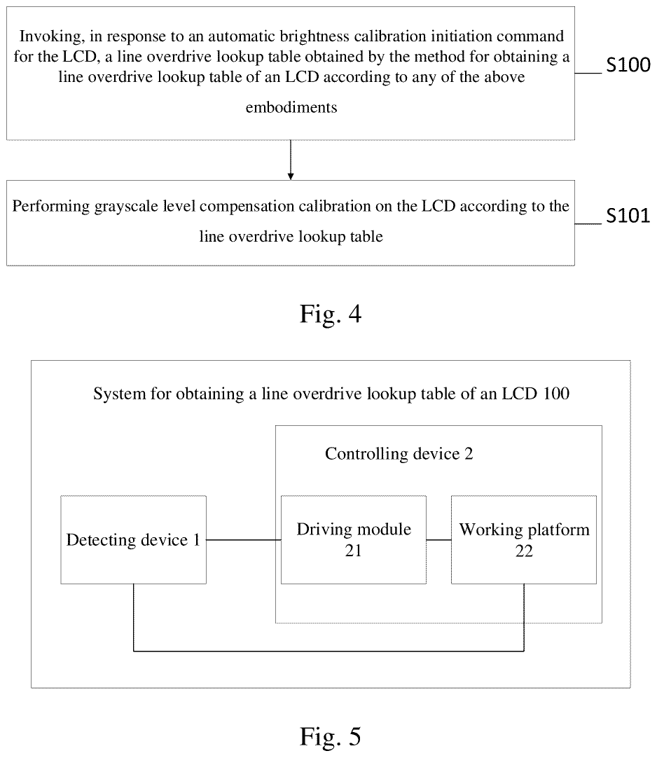

An automatic brightness calibration method for an LCD according to an embodiment of the present disclosure is described below with reference to FIG. 4.

FIG. 4 is a flow chart of an automatic brightness calibration method for an LCD according to an embodiment of the present disclosure. As shown in FIG. 4, the automatic brightness calibration method for an LCD according to the embodiment of the present disclosure at least includes steps S100-S101.

At step S100, in response to an automatic brightness calibration initiation command for the LCD, a line overdrive lookup table obtained by the method for obtaining a line overdrive lookup table of an LCD according to any of the above embodiments is invoked.

In some embodiments, the automatic brightness calibration initiation command for the LCD can be triggered based on various conditions to ensure timely brightness adjustment that meets application requirements. For example, ambient brightness change triggering, usage duration triggering, preset scheduled triggering, manual triggering, etc can be included.

Specifically, for ambient brightness change triggering, the system can be equipped with an ambient light sensor to monitor external light intensity in real time. When the ambient brightness change exceeds a set threshold (e.g., increases or decreases by 30%), the system automatically triggers brightness calibration to adapt to environmental changes. For usage duration triggering, the system records the cumulative operating duration of the LCD. Since the brightness and color of the LCD may deviate from their initial settings after prolonged use of the LCD, the system can automatically initiate brightness calibration after operating for a certain period (e.g., every 100 hours). For scheduled triggering, the system can set a fixed time interval (for example, every 24 hours) to automatically trigger brightness calibration. For manual triggering, a user can manually initiate brightness calibration through the operation interface. This approach proves useful in certain specific scenarios. For example, after installing a new screen or replacing the driving device, a user can manually calibrate the brightness to match other devices.

At step S101, grayscale level compensation calibration is performed on the LCD according to the line overdrive lookup table.

Specifically, the system reads the grayscale level compensation value corresponding to each grayscale level in the line overdrive lookup table, and selects the corresponding grayscale level compensation value based on the current grayscale level. These compensation values will subsequently be converted into actual driving voltage values through the digital-to-analog converter (DAC) within the LCD panel to adjust the brightness output of the LCD and to make it close to the target brightness.

Furthermore, during a gradual application process of grayscale level compensation values in the lookup table, the system can monitor brightness output in real-time through a photoelectric sensor and compare the current brightness with the target brightness. If it is found that the brightness deviation value still exceeds the set brightness deviation threshold, the grayscale level compensation calibration of the LCD can then be further performed to achieve the desired brightness.

Furthermore, after finishing adjustment, the system can save the relevant parameters and results during the adjustment process. such as brightness deviation value and corresponding grayscale level compensation value. These data can be used as reference for subsequent brightness calibration or provide a basis for future lookup table updates, ensuring that the latest compensation data can be directly referenced during subsequent startups and saving readjustment time.

Furthermore, a specific grayscale level value (such as a grayscale level value of a certain pixel) is inputted, a lookup operation is performed in the line overdrive lookup table, and a corresponding grayscale level value is output to the panel. The chip on film (COF) on the LCD panel is configured with a gate driver and a source driver. The source driver internally integrates a digital-to-analog converter (DAC, Digital-to-Analog Converter), which can convert a grayscale level value in a digital signal form into an analog driving voltage. The analog driving voltage after DAC conversion acts on the liquid crystal pixel, altering the alignment of liquid crystal molecules (i.e., “flipping”). This flipping process determines light transmittance and color performance of the pixels, achieving that the actual display effect is consistent with the expected input signal grayscale level or reaches an optimized result.

In some embodiments, the automatic brightness calibration method for an LCD of the embodiments of the present disclosure can be widely applied to LCD panels with different driving methods, such as Twisted Nematic (TN) driven LCD screen, In-Plane Switching (IPS) driven LCD screen, Vertical Alignment (VA) driven LCD screen, Multi-Domain Vertical Alignment (MVA) driven LCD screen, or LCD screens with other driving methods.

In the automatic brightness calibration method for an LCD according to the embodiment of the present disclosure, in response to an automatic brightness calibration initiation command for the LCD, the system can automatically invoke the line overdrive lookup table obtained by the method for obtaining a line overdrive lookup table of an LCD according to the embodiment above. The lookup table records the target grayscale level compensation values for the LCD at different grayscale levels. Based on these compensation values, the system can adjust the input grayscale signal. These signals are converted into actual driving voltage values through the digital-to-analog converter (DAC) inside the LCD panel. Therefore, through adjusting the grayscale level signal using the target grayscale level compensation value, the system can indirectly achieve adjustment of the driving voltage. By accelerating or decelerating the charging and discharging process of the LCD, deviations in the output brightness of the LCD screen can be compensated for, to ensure that the brightness performance of different grayscale levels and different color channel combinations meets expectations. This method can complete brightness calibration without manual operation, making the operation process more simplified, reducing human errors, and ensuring that the brightness performance of the LCD screen become more uniform and precise. This enhances the consistency and accuracy of the LCD screen's brightness performance across various grayscale levels and color combinations, further optimizing the display quality of the LCD panel.

A system for obtaining a line overdrive lookup table of an LCD according to an embodiment of the present disclosure is described below with reference to FIG. 5.

FIG. 5 is a block diagram of a system for obtaining a line overdrive lookup table of an LCD according to an embodiment of the present disclosure. As shown in FIG. 5, the system 100 for obtaining a line overdrive lookup table of an LCD includes a detecting device 1 and a controlling device 2.

In some embodiments, the detecting device 1 can be a color analyzer or a photoelectric sensor and is configured to detect a brightness value of a target LCD. The color analyzer can accurately measure the color brightness distribution of the LCD under different grayscale level driving conditions. The color analyzer can be equipped with built-in optical filters and multi-channel detectors and is capable of simultaneously acquiring brightness information from a plurality of color channels such as RGB. The photoelectric sensor determines the screen brightness by detecting the intensity of light. The sensor has the feature of rapid response, and is capable of quickly capturing screen brightness values under different grayscale level driving conditions, making it suitable for scenarios with high real-time requirements.

In some embodiments, the detecting device 1 can obtain brightness values from any position within the screen area, without limiting to a fixed location. The measurement area is adjusted according to requirements to conduct a comprehensive analysis of the brightness of the entire screen. The angle of the detecting device 1 when collecting brightness data can be perpendicular to the display panel or form a certain angle with the panel. The angle can be flexibly adjusted according to specific measurement requirements within a range between 0° and 180°. This ensures accurate acquisition of a brightness signal of the display panel under different angles, thereby adapting to various usage scenarios and requirements.

In some embodiments, the controlling device 2 is connected to the detecting device 1 and is configured to perform the method for obtaining a line overdrive lookup table of an LCD according to any of the above embodiments to analyze and calculate the brightness data corresponding to different grayscale levels. The controlling device 2 can adjust the grayscale level compensation value based on the brightness deviation of each grayscale level until the target grayscale level compensation value meeting the brightness deviation threshold requirement is obtained.

In the system 100 for obtaining a line overdrive lookup table of an LCD according to the embodiment of the present disclosure, the controlling device 2 is connected to the detecting device 1 and implements the method for obtaining a line overdrive lookup table of an LCD as described in any of the above embodiments to drive the LCD to output images with different color channel combinations under a grayscale level n and obtain a mixed brightness value that is corresponding to each color channel combination and a plurality of brightness component values corresponding to each color channel combination, which can accurately reflect the brightness performance of each color channel combination and a plurality of corresponding single color channels on the LCD under different grayscale levels. By calculating a brightness deviation between a sum of the plurality of brightness component values and the corresponding mixed brightness value, the difference between the actual brightness performance and the expected brightness performance of the LCD under the current driving condition can be evaluated. Based on the deviation direction of the brightness deviation and by using a preset calibration algorithm, a required adjustment or compensation value for each input grayscale level signal, that is the target grayscale level compensation value corresponding to the current grayscale level n, can be automatically calculated and is recorded, to facilitate subsequent correction of the brightness output by the LCD. The aforementioned process will be repeated, until the target grayscale level compensation values corresponding to all grayscale levels are obtained, thereby automatically generating a calibrated line overdrive lookup table. Through the method of the present disclosure, there is no need to rely on human power for testing and comparison, thereby simplifying the operation process, reducing human errors, and improving the accuracy of the line overdrive lookup table, thereby providing precise data support for the subsequent automatic calibration of the LCD brightness.

In some embodiments, as shown in FIG. 5, the controlling device 2 includes a driving module 21 and a working platform 22. The driving module 21 can be a System on Chip (SOC) driving board with a built-in Timing Controller (Tcon) therein, a driving board with an external Tcon, or a device capable of outputting color signals to drive the LCD panel.

The SOC driver board with the built-in Tcon integrates the timing controller and the system-on-chip together, enabling the module to have enhanced processing and control capabilities. The SOC driver board with the built-in Tcon can directly manage the grayscale level driving signals and color signal processing of the display panel, thereby precisely controlling the brightness of the panel. The driving board with the external TCON separates the timing controller from the main control chip, and is specifically designed to process display data and generate signal formats suitable for display panels. The driving board with the external TCON is suitable for application scenarios requiring more flexible signal processing, such as display devices with higher refresh rates so as to ensure smooth brightness adjustment. The device for outputting color signals to drive the LCD panel can adopt digital-to-analog converter (DAC) technology to convert digital signals into analog signals for driving the LCD panel.

In some embodiments, the driving module 21 is provided with the line overdrive lookup table and is configured to drive the target LCD based on the line overdrive lookup table. Specifically, the driving module 21 loads or accesses the generated line overdrive lookup table before operation. The lookup table contains the target grayscale level compensation values for individual grayscale levels of the LCD. The system can directly invoke data in the table to control the grayscale level compensation value under each grayscale level.

In some embodiments, the driving module 21 looks up the corresponding grayscale level compensation value based on the input grayscale level value through looking up the table and transmits the grayscale level compensation value to the panel control module of the LCD. A COF component in the LCD panel includes a source driver and a gate driver and is configured to convert a digital signal transmitted by the driving module 21 into a voltage signal required by the panel. During the LCD brightness calibration process, if the brightness value displayed by the feedback from detecting device 1 deviates from the target brightness value, the driving module 21 can perform grayscale level compensation calibration on the LCD according to the line overdrive lookup table until the display brightness reaches a calibration target.

In some embodiments, the working platform 22 is a control center of the entire system, is connected with the detecting device 1 and the driving module 21, and is configured to obtain the brightness value and control the driving module. Specifically, the working platform 22 sends the LCD automatic brightness calibration start command to the driving module 21 to control the output of RGB combination data under different grayscale levels and transmit these data to the LCD panel for display. At the same time, the working platform 22 can receive the current displayed brightness data measured by the detecting device 1 and record the brightness value of an RGB combination and a plurality of brightness component values corresponding to the RGB combination under different grayscale levels n.

Furthermore, based on the gate driving mode of the LCD panel (such as single gate, dual gate, tri gate, etc.), the source driving mode of the panel (such as the flip mode (the flip source driving mode), the stripe mode (the stripe source driving mode), etc.), and the liquid crystal structure mode of the panel (such as IPS mode (in-plane switching mode), VA mode (vertical alignment mode), etc.), and before the LOD function is not enabled in the panel, the panel itself displays RGB pure colors and mixed colors (such as color saturation and color coordinates) to select the color channel combination and automatically choose different calculation calibration methods to calculate the brightness deviation between a sum of a plurality of brightness component values and the corresponding mixed brightness value.

Furthermore, based on the deviation direction of the brightness deviation (greater than or less than the brightness deviation threshold), the corresponding target grayscale level compensation value for the current grayscale level n is calculated, and is sent to the driving module 21 to correct the data in the line overdrive lookup table. The driving module 21 outputs the corrected RGB combination image under the grayscale level n based on the calibrated line overdrive lookup table, and the corrected RGB combination image is then displayed again on the LCD.

Furthermore, after finishing calibration, the working platform 22 will once again obtain the brightness data measured by detecting device 1 and recalculate the brightness deviation. If the brightness reaches the predetermined calibration value, the system will jump to an RGB combination measurement stage under a next grayscale level (the grayscale level n+1 or n−1) and continue with measurement and calibration.

In some embodiments, the working platform 22 can be a handheld laptop, a desktop laptop, or any other device capable of receiving brightness values and controlling the driving module 21. Furthermore, the line overdrive lookup table can also be temporarily stored on the working platform 22, facilitating the management of calibration data and subsequent data invocations.

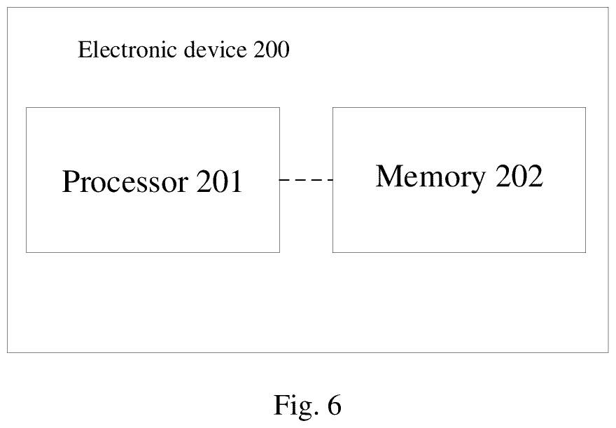

An electronic device according to an embodiment of the present disclosure is described below with reference to FIG. 6.

FIG. 6 is a block diagram of an electronic device according to an embodiment of the present disclosure. As shown in FIG. 6, the electronic device 200 includes: a memory 202 and at least one processor 201.

In some embodiments, the at least one processor 201 can be a single processor 201, or a plurality of processors 201 such as two processors 201, three processors 201 and five processors 201, etc. The processor 201 can be a single-core or multi-core processor 201 and is configured to execute a computer program stored in memory 202, process brightness detection data, calculate target grayscale level compensation values, and a generate line overdrive lookup table. The processor 201 can be a central processing unit (CPU), graphics processing unit (GPU), or a dedicated processing unit (such as a digital signal processor DSP (DSP), a microcontroller MCU (Microcontroller Unit), etc.). The specific choice of the processor 201 depends on the design and purpose of the electronic device 200.

In some embodiments, the memory 202 can be used to store computer programs and other necessary data. The memory 202 may include various types, such as Random Access Memory (RAM), Read-Only Memory (ROM), Flash Memory, etc. When the system operates, the memory 202 can load the programs and parameters for generation and calibration of the line overdrive lookup table, ensuring that the processor 201 can quickly access the required data and implement the corresponding algorithms. The memory 202 can also store the generated line overdrive lookup table, brightness measurement data, and calibration results for subsequent invocation or recording.

In some embodiments, the memory 202 stores a computer program executable by the at least one processor 201. The computer program when executed by the at least one processor 201, implements the method for obtaining a line overdrive lookup table of an LCD according to any of the above embodiments or implements the automatic brightness calibration method for an LCD according to any of the above embodiments.

The electronic device 200 according to the embodiment of the present disclosure, through executing the method for obtaining a line overdrive lookup table of an LCD in any of the above embodiments or implementing the computer program for an automatic brightness calibration method for an LCD in any of the above embodiments, achieves automated operations of line overdrive lookup table generation and brightness calibration. The entire process does not need to be relied on manual testing and comparison, simplifying the operational process, reducing human errors, and improving the accuracy of the line overdrive lookup table, thereby ensuring the consistency and accuracy of brightness performance across various grayscale levels and color combinations of the LCD, ultimately enhancing the display quality of LCD panels.

An embodiment of the present disclosure provides a non-transitory computer readable storage medium, on which a computer program is stored. The computer program when executed by a processor 201, implements the method for obtaining a line overdrive lookup table of an LCD according to any of the above embodiments, or implements the automatic brightness calibration method for an LCD according to any of the above embodiments. For the specific implementation process of the method for obtaining a line overdrive lookup table of an LCD and the automatic brightness calibration method for an LCD, the description in any of the above embodiments can be referred to.

The non-transitory computer readable storage medium according to the embodiment of the present disclosure, by using the method for obtaining a line overdrive lookup table of an LCD in any of the above embodiments or the automatic brightness calibration method for an LCD in any of the above embodiments, achieves automated operations of line overdrive lookup table generation and brightness calibration. The entire process does not need to be relied on manual testing and comparison, simplifying the operational process, reducing human errors, and improving the accuracy of the line overdrive lookup table, thereby ensuring the consistency and accuracy of brightness performance across various grayscale levels and color combinations of the LCD, ultimately enhancing the display quality of LCD panels.

In the illustration of the present description, a description with reference to the terms “one embodiment,” “some embodiments,” “exemplary embodiments,” “examples,” “specific examples,” or “some examples,” etc. means that a specific feature, structure, material, or characteristic described in connection with the embodiment or example is included in at least one embodiment or example of the present disclosure. In the present description, schematic expressions of the above terms do not necessarily refer to the same embodiments or examples.

Although embodiments of the present disclosure have been shown and described, those of ordinary skill in the art can understand that various changes, modifications, substitutions, and variations can be made to these embodiments without departing from the principles and spirit of the present disclosure. The scope of the invention is defined by the claims and their equivalents.

What is claimed is:

1. A method for obtaining a line overdrive lookup table of a liquid crystal display (LCD), comprising:
driving the LCD to output images with different color channel combinations under a grayscale level n;
obtaining a mixed brightness value of the LCD that is corresponding to each color channel combination and a plurality of brightness component values corresponding to the color channel combination;
obtaining a brightness deviation between a sum of the plurality of brightness component values and the corresponding mixed brightness value;
obtaining a target grayscale level compensation value corresponding to the current grayscale level n based on a deviation direction of the brightness deviation; and
obtaining target grayscale level compensation values corresponding to all grayscale levels to form the line overdrive lookup table.

2. The method according to claim 1, wherein said driving the LCD to output the images with the different color channel combinations under the grayscale level n comprises:
successively outputting images with different color channel combinations under different grayscale levels in an ascending or descending order; or
driving, according to a preset way, the LCD to output to poll grayscale levels segmented by all grayscale level compensation values.

3. The method according to claim 1, further comprising:
selecting the color channel combination based on a color channel arrangement structure or a driving mode of the LCD.

4. The method according to claim 1, wherein said obtaining the mixed brightness value of the LCD that is corresponding to each color channel combination and the plurality of brightness component values corresponding to the color channel combination comprises at least one of:
obtaining a mixed brightness value of the LCD that is corresponding to a simultaneous driving of an R channel, a B channel and a G channel, a brightness component value of the R channel, a brightness component value of the B channel and a brightness component value of the G channel that are corresponding to the color channel combination;
obtaining the mixed brightness value of the LCD that is corresponding to a simultaneous driving of the R channel, the B channel and the G channel, the brightness component value of the R channel and a brightness component value of a combination of the B channel and the G channel that are corresponding to the color channel combination;
obtaining the mixed brightness value of the LCD that is corresponding to a simultaneous driving of the R channel, the B channel and the G channel, the brightness component value of the G channel and a brightness component value of a combination of the R channel and the B channel that are corresponding to the color channel combination; or
obtaining the mixed brightness value of the LCD that is corresponding to a simultaneous driving of the R channel, the B channel and the G channel, the brightness component value of the B channel, and a brightness component value of a combination of the R channel and the G channel that are corresponding to the color channel combination.

5. The method according to claim 1, wherein said obtaining the mixed brightness value of the LCD that is corresponding to each color channel combination and the plurality of brightness component values corresponding to the color channel combination comprises at least one of:
obtaining a mixed brightness value of the LCD that is corresponding to a simultaneous driving of an R channel and a B channel, a brightness component value of the R channel and a brightness component value of the B channel that are corresponding to the color channel combination;
obtaining a mixed brightness value of the LCD that is corresponding to a simultaneous driving of the R channel and a G channel, the brightness component value of the R channel and a brightness component value of the G channel that are corresponding to the color channel combination; or
obtaining a mixed brightness value of the LCD that is corresponding to a simultaneous driving of the G channel and the B channel, the brightness component value of the G channel and the brightness component value of the B channel that are corresponding to the color channel combination.

6. The method according to claim 1, wherein said obtaining the target grayscale level compensation value corresponding to the current grayscale level n based on the deviation direction of the brightness deviation comprises:
determining, when a value of the brightness deviation is less than a brightness deviation threshold, a current grayscale level compensation value of the LCD as the target grayscale level compensation value corresponding to the current grayscale level n.

7. The method according to claim 6, wherein said obtaining the target grayscale level compensation value corresponding to the current grayscale level n based on the deviation direction of the brightness deviation further comprises:
adjusting, when the brightness deviation value is greater than or equal to the brightness deviation threshold, the current grayscale level compensation value of the LCD according to the deviation direction; and
obtaining a new brightness deviation value, and adjusting the grayscale level compensation value of the LCD based on a deviation direction of the new brightness deviation value until the brightness deviation value is less than the brightness deviation threshold.

8. The method according to claim 1, wherein said obtaining the target grayscale level compensation value corresponding to the current grayscale level n based on the deviation direction of the brightness deviation comprises:
adjusting, via dichotomy, the grayscale level compensation value based on a value between a maximum allowable grayscale level compensation value and a minimum allowable grayscale level compensation value of the current grayscale level n until the brightness deviation value is less than or equal to the brightness deviation threshold; or
repeatedly increase or decrease the gray scale compensation value by one according to the deviation direction of the brightness deviation until the brightness deviation value is less than or equal to the brightness deviation threshold.

9. The method according to claim 7, wherein the brightness deviation threshold is set according to a color channel arrangement structure of the LCD or is a customized value.

10. The method according to claim 1, further comprising:
exporting the line overdrive lookup table and saving it in a preset file format.

11. An automatic brightness calibration method for an LCD, comprising:
invoking, in response to an automatic brightness calibration initiation command for the LCD, a line overdrive lookup table obtained by operations of:
driving the LCD to output images with different color channel combinations under a grayscale level n;
obtaining a mixed brightness value of the LCD that is corresponding to each color channel combination and a plurality of brightness component values corresponding to the color channel combination;
obtaining a brightness deviation between a sum of the plurality of brightness component values and the corresponding mixed brightness value;
obtaining a target grayscale level compensation value corresponding to the current grayscale level n based on a deviation direction of the brightness deviation; and
obtaining target grayscale level compensation values corresponding to all grayscale levels to form the line overdrive lookup table; and
performing grayscale level compensation calibration on the LCD according to the line overdrive lookup table.

12. A system for obtaining a line overdrive lookup table of an LCD, comprising:
a detecting device configured to detect a brightness value of a target LCD; and
a controlling device connected to the detecting device and configured to perform operations of:
driving the LCD to output images with different color channel combinations under a grayscale level n;
obtaining a mixed brightness value of the LCD that is corresponding to each color channel combination and a plurality of brightness component values corresponding to the color channel combination;
obtaining a brightness deviation between a sum of the plurality of brightness component values and the corresponding mixed brightness value;
obtaining a target grayscale level compensation value corresponding to the current grayscale level n based on a deviation direction of the brightness deviation; and
obtaining target grayscale level compensation values corresponding to all grayscale levels to form the line overdrive lookup table.

13. The system according to claim 12, wherein said driving the LCD to output the images with the different color channel combinations under the grayscale level n comprises:
successively outputting images with different color channel combinations under different grayscale levels in an ascending or descending order; or
driving, according to a preset way, the LCD to output to poll grayscale levels segmented by all grayscale level compensation values.

14. The system according to claim 12, wherein the controlling device is further configured to perform an operation of:
selecting the color channel combination based on a color channel arrangement structure or a driving mode of the LCD.

15. The system according to claim 12, wherein said obtaining the mixed brightness value of the LCD that is corresponding to each color channel combination and the plurality of brightness component values corresponding to the color channel combination comprises at least one of:
obtaining a mixed brightness value of the LCD that is corresponding to a simultaneous driving of an R channel, a B channel and a G channel, a brightness component value of the R channel, a brightness component value of the B channel and a brightness component value of the G channel that are corresponding to the color channel combination;
obtaining the mixed brightness value of the LCD that is corresponding to a simultaneous driving of the R channel, the B channel and the G channel, the brightness component value of the R channel and a brightness component value of a combination of the B channel and the G channel that are corresponding to the color channel combination;
obtaining the mixed brightness value of the LCD that is corresponding to a simultaneous driving of the R channel, the B channel and the G channel, the brightness component value of the G channel and a brightness component value of a combination of the R channel and the B channel that are corresponding to the color channel combination; or
obtaining the mixed brightness value of the LCD that is corresponding to a simultaneous driving of the R channel, the B channel and the G channel, the brightness component value of the B channel, and a brightness component value of a combination of the R channel and the G channel that are corresponding to the color channel combination.

16. The system according to claim 12, wherein said obtaining the mixed brightness value of the LCD that is corresponding to each color channel combination and the plurality of brightness component values corresponding to the color channel combination comprises at least one of:
obtaining a mixed brightness value of the LCD that is corresponding to a simultaneous driving of an R channel and a B channel, a brightness component value of the R channel and a brightness component value of the B channel that are corresponding to the color channel combination;
obtaining a mixed brightness value of the LCD that is corresponding to a simultaneous driving of the R channel and a G channel, the brightness component value of the R channel and a brightness component value of the G channel that are corresponding to the color channel combination; or
obtaining a mixed brightness value of the LCD that is corresponding to a simultaneous driving of the G channel and the B channel, the brightness component value of the G channel and the brightness component value of the B channel that are corresponding to the color channel combination.

17. The system according to claim 12, wherein said obtaining the target grayscale level compensation value corresponding to the current grayscale level n based on the deviation direction of the brightness deviation comprises:
determining, when a value of the brightness deviation is less than a brightness deviation threshold, a current grayscale level compensation value of the LCD as the target grayscale level compensation value corresponding to the current grayscale level n.

18. The system according to claim 12, wherein the controlling device comprises:
a driving module provided with the line overdrive lookup table and configured to drive the target LCD based on the line overdrive lookup table;
a working platform connected with the detecting device and the driving module and configured to obtain the brightness value and control the driving module.

19. An electronic device, comprising:
at least one processor; and
a memory communicatively connected to the at least one processor;
wherein the memory stores a computer program executable by the at least one processor, the computer program when executed by the at least one processor, implements the method for obtaining a line overdrive lookup table of an LCD according to claim 1.

20. A computer non-transitory readable storage medium, on which a computer program is stored, wherein the computer program when executed, implements the method for obtaining a line overdrive lookup table of an LCD according to claim 1.
